(19) United States
(12) Patent Application Publication
(10) Pub. No.: US 2008/0236111 A1
(43) Pub. Date: Oct. 2, 2008

(54) Bitless Bridle with Crossover Reinstrap Stabilizer

(76) Inventor: Zoe C. Brooks, Worthington (CA)

Correspondence Address: BERESKIN AND PARR, 40 KING STREET WEST, BOX 401, TORONTO, ON, M5H 3Y2, CA

(21) Appl. No.: 12/066,167

(22) PCT Filed: Sep. 28, 2006
(86) PCT No.: PCT/CA2006/001597

§ 371 Date: Mar. 7, 2008

(30) Foreign Application Priority Data
Sep. 29, 2005 (CA) 2522524

(51) Int. Cl. B68B 1/04

(52) U.S. Cl. 54/6.1

(57) ABSTRACT

A bitless bridle with crossover reinstrap stabilizer in English and Western style for riding, driving and training horses and like animals that achieves improved turning and slowing/stopping by threading reinstraps through a crossover reinstrap stabilizer under the horse's jaw, lining the inside of the noseband with rubber gripping or similar textured material, and improved arrangement of component straps. In both styles, a single crownpiece strap over the poll attaches on each side of the face to reinstraps that pass across the animal's cheek, through a crossover rein strap stabilizer under its jaw, then through rings attached to a noseband, and finally to reins. Pulling on a single rein places pressure on the reinstrap on the cheek of the opposite side of the animal's head, causing it to turn in the direction pulled. Pulling on a both reins places pressure on the noseband and the poll, causing the animal to slow or stop.

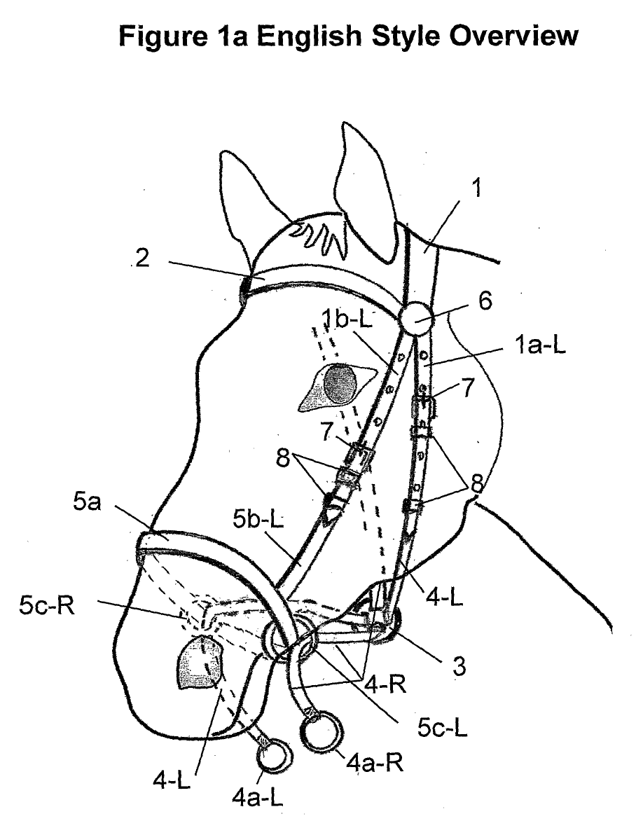

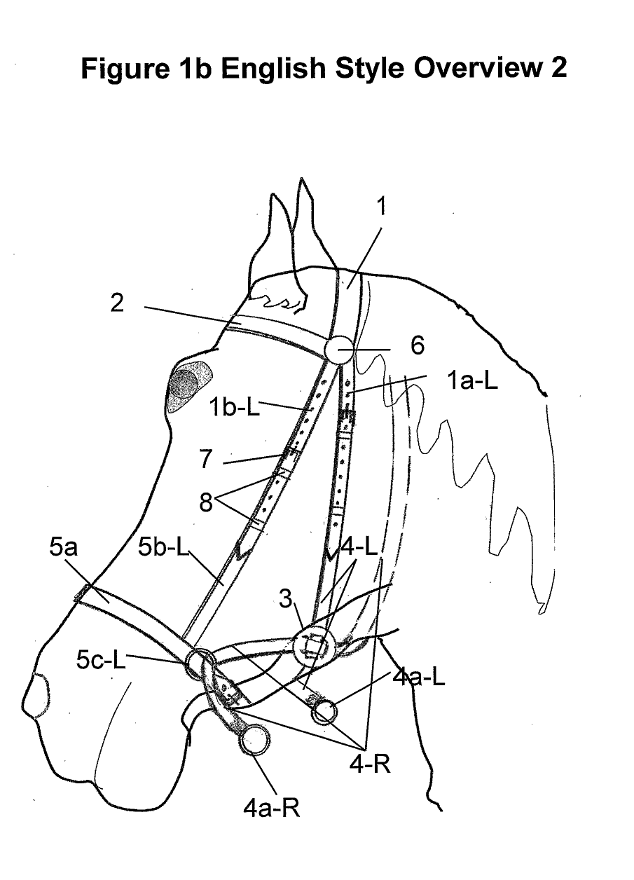

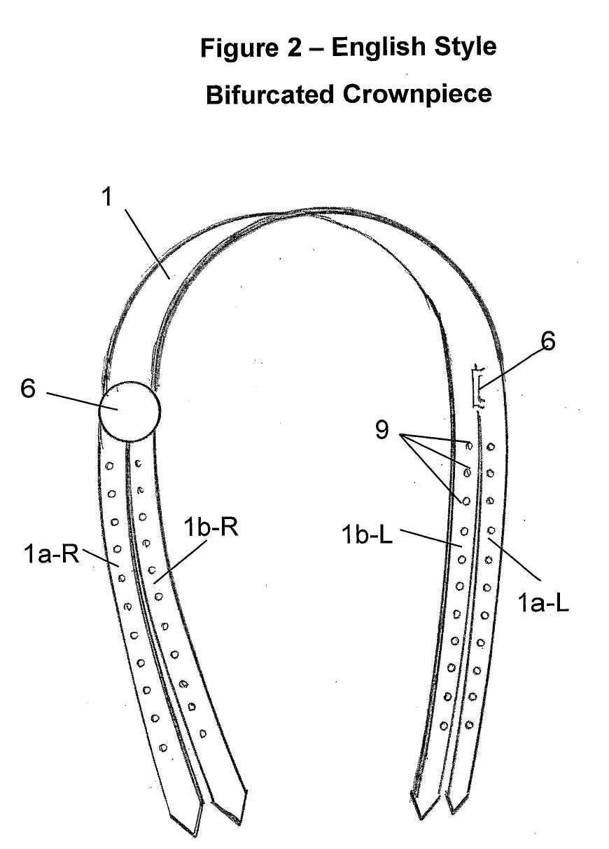

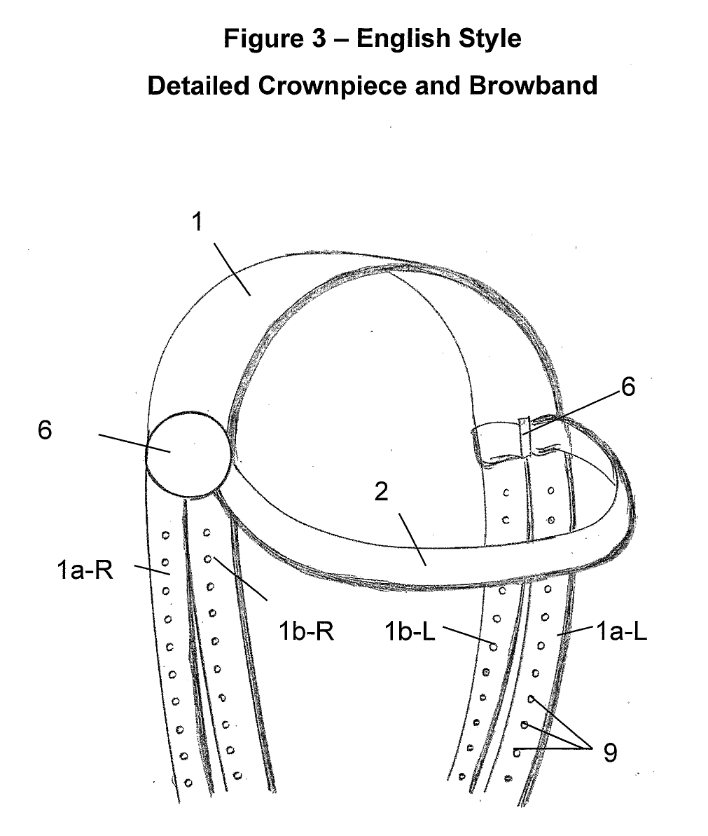

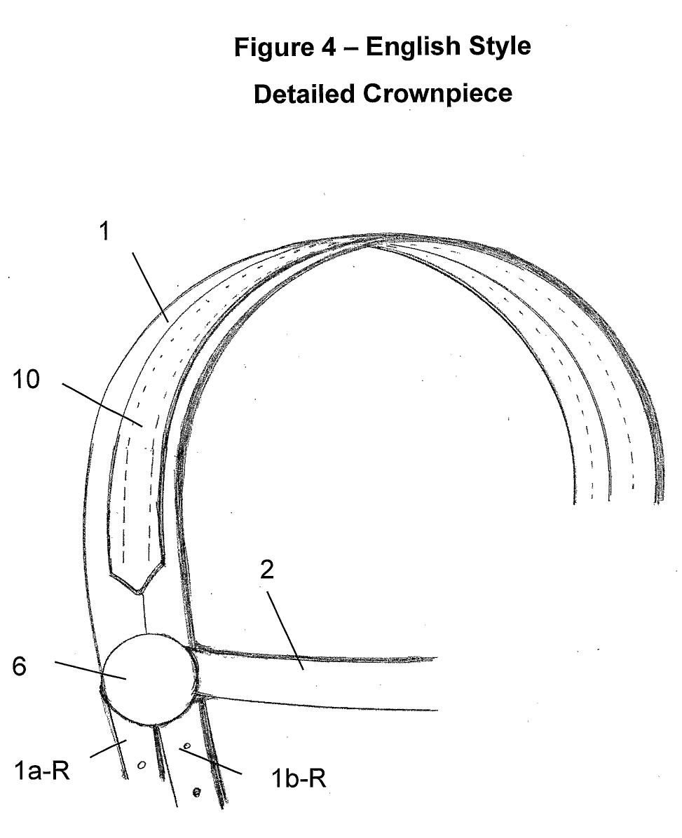

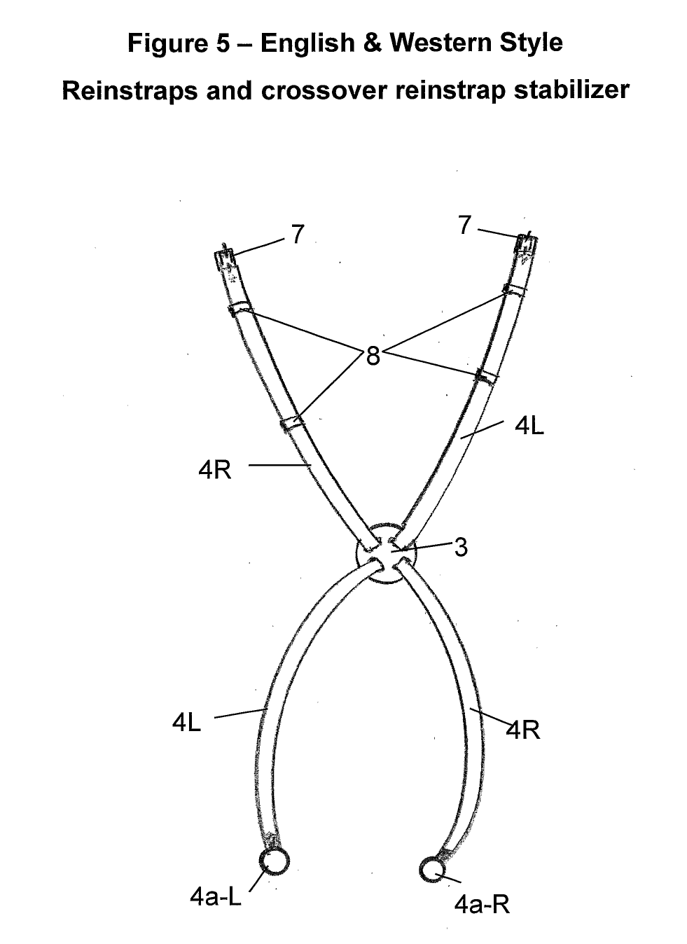

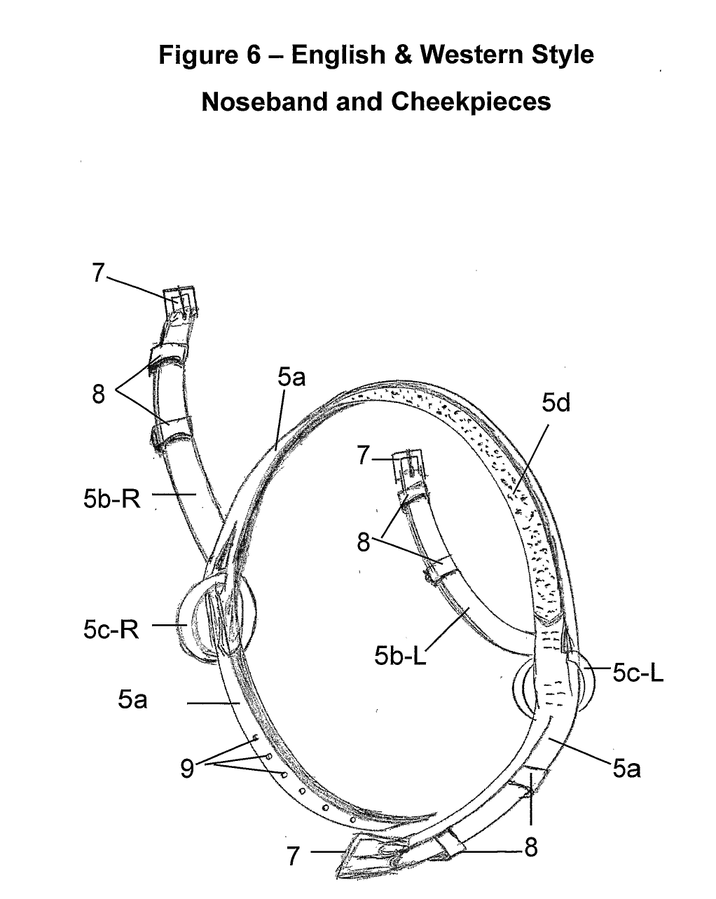

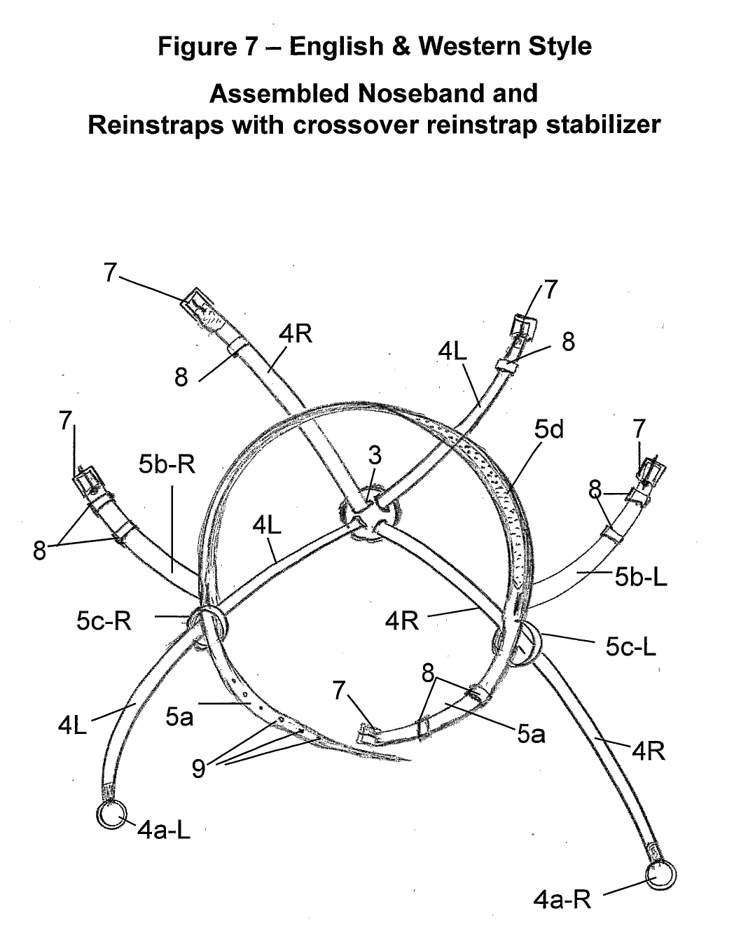

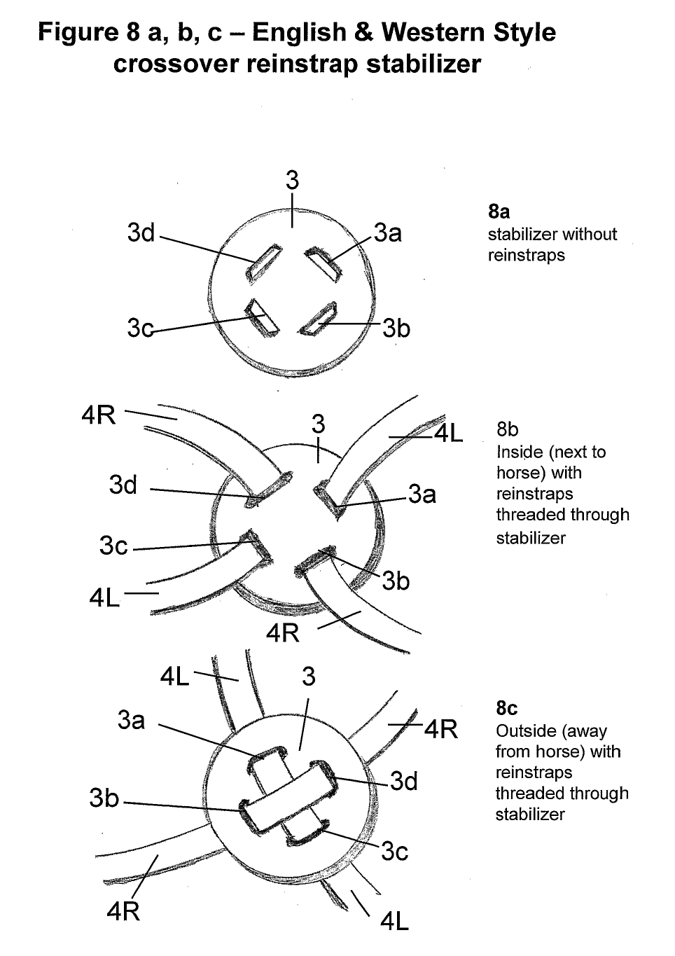

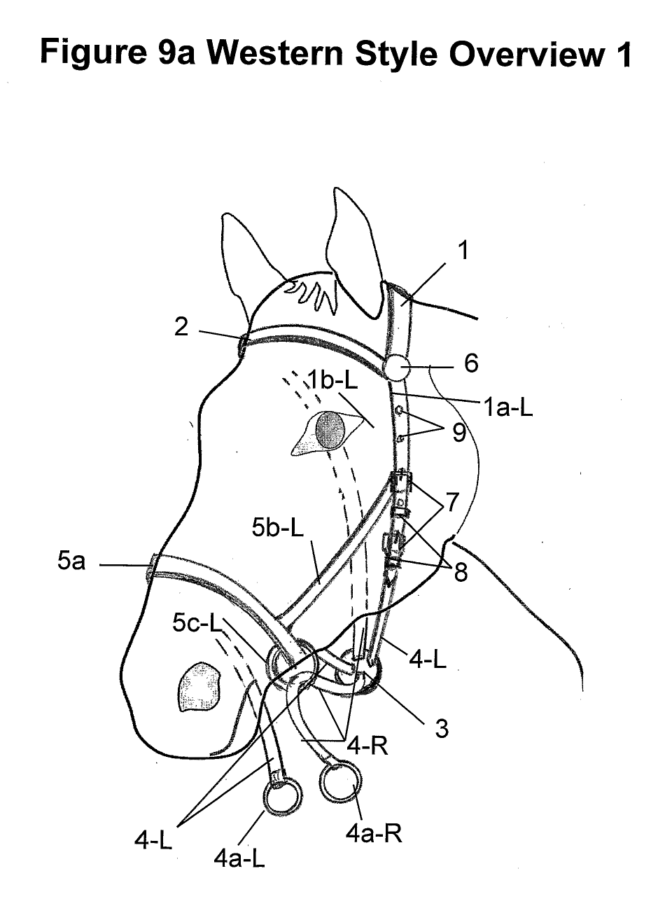

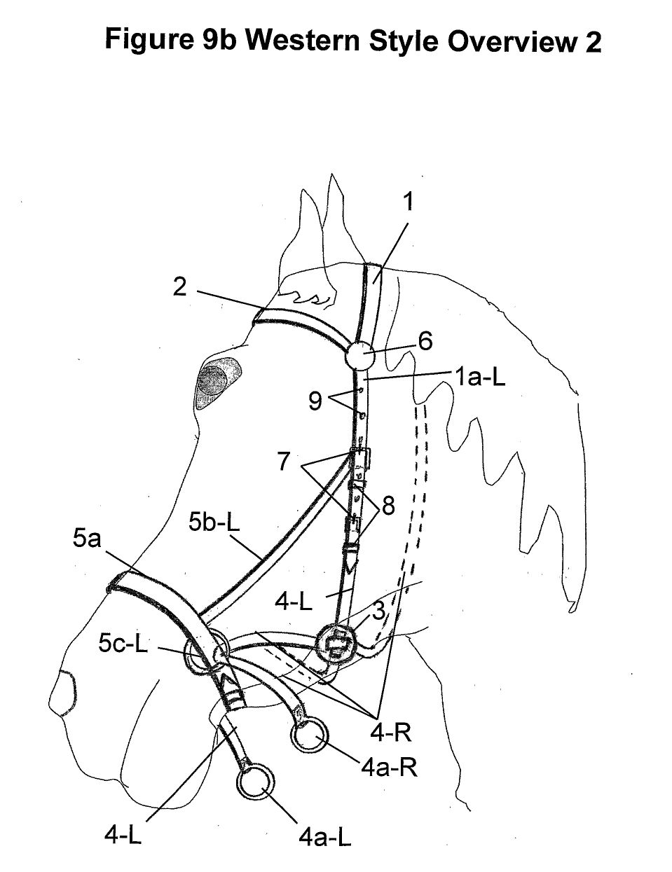

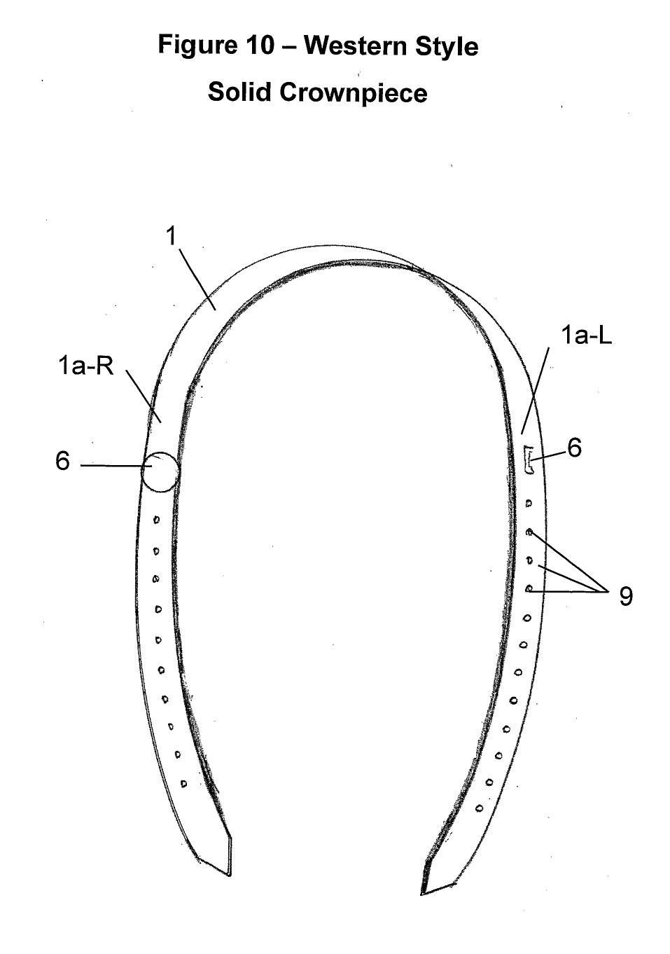

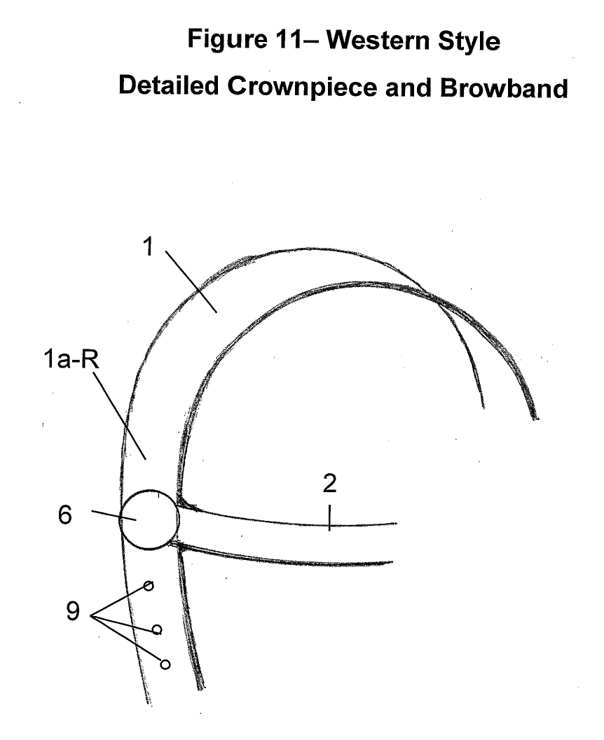

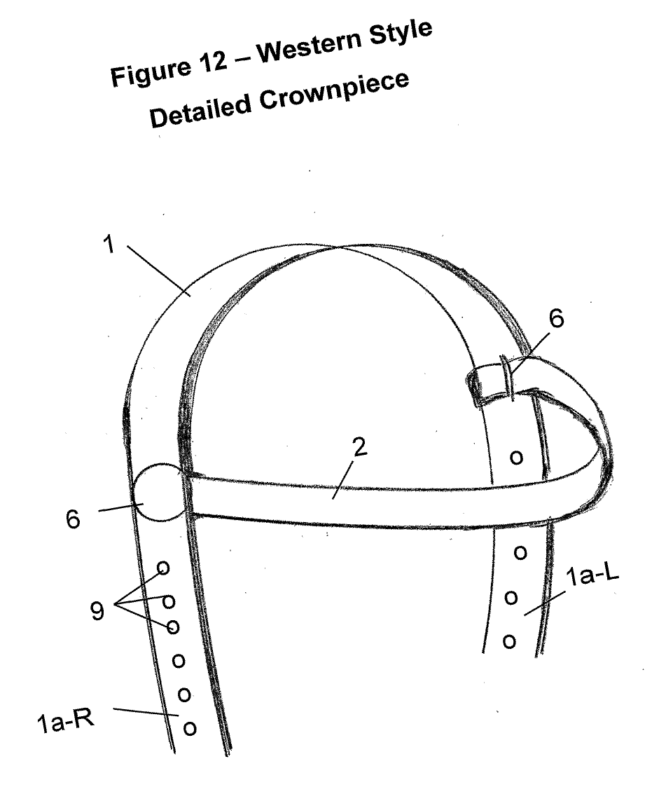

### TECHNICAL FIELD

This invention relates to devices in connection with harness, for hitching, reining, training, breaking, or quietening horses or other traction animals.

### BACKGROUND INFORMATION AND PRIOR ART

It is known that bridles for riding, driving and training horses typically control the direction and momentum of the animal by exerting force on a metal bit inserted in the horse's mouth, causing the horse to turn or stop in response to pain, discomfort or pressure of the bit. When the rider or driver applies pressure to a single rein, the bit is pulled backward into the horse's mouth and against the tongue, gums and lips, causing the horse to turn in the direction of the pull in an effort to lessen the discomfort. When the rider or driver applies pressure to both reins, the bit puts pressure on the tongue, gums and lips, causing the horse to slow or stop. Such bitted bridles cause pain to the horse and create an adversarial relationship. The pain of the bit causes many horses to evade the bit, become agitated or even run away. A bit in the horse's mouth often leads to cutting of the tongue, dental pain and severe bruising of the gums and underlying bone.

Various bitless or no-bit bridles or devices also exist. Bitted and bitless bridles affect the control of turning, slowing or stopping a horse by transferring pressure from a person's hands on reins or driving lines (referred to hereafter as reins) to specific points inside the horse's mouth or on the horse's head, Differences in structure of these bridles create different patterns of pressure points and thus impact the effect that the bridle produces on the horse. The current invention is constructed from five component pieces that create its unique structure and function:
1. a crownpiece with a solid central section over the horse's poll and solid or bifurcated ends that extend down the side of the horse's head,
2. a browband that connects to each side of the crownpiece,
3. a crossover reinstrap stabilizer: a circle of leather with opposing slots that connects two reinstraps as they cross through it beneath the horse's jaw.
4. a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, approximately 5 to 15 cm from the horse's lipcrease,
5. a noseband with a textured inner lining on the portion over the nose, with metal rings affixed at each side; that is adjustably attached to each side of the crownpiece, that encircles the horse's nose and closes in a buckle beneath the chin.

In the 1913 United Kingdom patent # 5786, Chedeville discloses a bitless bridle formed by a combination of a rigid framework and a leather devise comprising cheek straps that meet together at a throat strap. The cheek straps originate from a connector connecting the nose, chin, cheek and side straps. The cheek straps terminate at the bottom of the throat strap. Chedevilles's bridle includes a rigid framework of metal of wooden parts while the current invention is constructed entirely of flexible strapping of material such as leather or nylon or biothane. Differences in structure between the current invention and Chedeville's bridle alter the pattern of pressure points and thus the ultimate effect that each bridle produces on a horse.
1. Where the current invention has a crownpiece with a solid central section over the horse's poll and solid or bifurcated ends that extend down the side of the horse's head, Chedeville's bridle differs in that it utilizes a crownpiece that passes only over the horse's poll, does not extend down the side of the horse's head and is not attached to reinstraps. Chedeville's bridle utilizes a throatlatch that passes under the throat of the horse and connects the two sides of the crownpiece while the current invention has no similar device. Functional differences associated with design of the crownpiece include: (a) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. In Chedeville's bridle, the traction exerted by reins causes the framework to oscillate in such a way that it causes the leather device to press simultaneously on the lower and outer par of the two lower maxillaries near the throat, on the upper pan of the forehead, on the top of the head immediately behind the ears and on the rear of the basis of the ears. In contrast, the minimal pressure applied by the current invention is distributed evenly over the poll.
2. Browbands of these, and most bridles, are similar
3. Where an integral part of the current invention is a crossover reinstrap stabilizer: a circle of leather with opposing slots that connects two reinstraps as they cross through under the horse's jaw, Chedeville's bridle has no comparable feature. The cheek straps that terminate at the bottom of the throat strap do not cross over each other or connect to reins. Functional differences associated with design of the crossover reinstrap stabilizer include: (a) The crossover reinstrap stabilizer of the current invention maintains reinstraps in a constant position on the side of the horse's head and underneath the jaw. In Chedeville's bridle, the cheek straps do not cross the fat part of the horse's cheek. (b) In the current invention, pressure on the crossover reinstrap stabilizer signals the horse to turn or slow. No similar pressure is applied under the jaw by the Chedeville bridle.
4. Where the current invention has a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, Chedeville's bridle differs in that the reinstraps are not employed, but reins attach directly to the extremities of the rigid framework. Functional differences associated with design of the reinstraps include: (a) The reinstraps of the current invention may be adjusted so reins attach close to the horse's mouth to improve communication with the horse and allow this bridle to more closely mimic the action of a bitted bridle. In the Chedeville bridle, the reins attach to the rigid framework that extends well beyond the home's mouth, far away from the normal position for a bitted bridle, causing a delay or distortion in transfer of pressure from the reins to the remaining bridle components, thus creating poorer communication between rider/driver and horse and diminishing rein control. (b) The pressure points acted upon by the current invention differ from those acted upon by Chedeville's bridle. In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. In Chedeville's bridle, the traction exerted by reins causes the framework to oscillate in such a way that it causes the leather device to press simultaneously on the lower and outer part of the two lower maxillaries near the throat, on the upper part of the forehead, on the top of the head immediately behind the ears and on the rear of the basis of the ears.
5. Where the current invention has a noseband with a textured inner lining on the portion over the nose, with metal rings affixed at each sides that is adjustably attached to each side of the crownpiece, that encircles the horse's nose and closes in a buckle beneath the chin such that the ending portion of the noseband does not usually pass through the ring on the noseband. Chedeville's bridle differs in that it has no upper portion to the noseband and only employs a chinstrap connecting the rigid framework at each side of the face, near the lipcrease. Functional differences associated with design of the noseband include: (a) In the current invention, when a person's hands act on reins attached to the bridle's reinstraps, pressure from the reinstraps is transferred to the rings of the noseband and the textured upper portion of the noseband, where it signals the horse to turn or slow. No similar pressure or action is accomplished by Chedeville's bridle as this bridle does not employ a noseband.

In a 1979 U.S. Pat. No. 4,132,054, Mader discloses a hackamore bridle that may be positioned on an animal such as a horse, with the bridle exerting pressure substantially only on the nose of the animal when the reins are pulled. The bridle includes a headstall having a pair of cheek plates connected between cheek straps and a chin strap so that the cheek plates are adjacent to the cheeks of the animal when the headstall is positioned on the head of the animal. Reins are connected to one end of a pair of rein levers, the other end of each of which is pivoted on the cheek plates. Differences in structure between the current invention and Mader's bridle alter the pattern of pressure points and thus the ultimate effect that each bridle produces on a horse.
1. Where the current invention has a crownpiece with a solid central section over the horse's poll and solid or biflurcated ends that extend down the side of the horse's head where they attach to reinstraps, Mader's bridle differs in that it utilizes a crownpiece that passes only over the horse's poll and does not extend down the side of the horse's head and is not attached to reinstraps. Mader's bridle utilizes a throatlatch that passes under the throat of the horse and connects the two sides of the crownpiece while the current invention has no similar device. Functional differences associated with design of the crownpiece include: (a) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with only marginal pressure transferred to the solid crownpiece over the poll. In Mader's bridle, when a person's hands act on reins attached to the rein lovers, this exerts a downward pull on the headstall, applying significant downward pressure on the crownpiece.
2. Browbands of these, and most bridles, are similar.
3. Where an integral part of the current invention is a crossover reinstrap stabilizer: a circle of leather with opposing slots that connects two reinstraps as they cross through under the horse's jaw, Mader's bridle has no comparable feature, and Mader's bridle does not include reinstraps. Functional differences associated with design of the crossover reinstrap stabilizer include: (a) The crossover reinstrap stabilizer of the current invention maintains the reinstraps in a constant position on the side of the horse's head and underneath the jaw. In Mader's bridle, minimal pressure is applied on the side of the horse's head or underneath the jaw.
4. Where the current invention has a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, Mader's bridle differs in that reinstraps are not employed. Functional differences associated with design of the reinstraps include: (a) The pressure points acted upon by the current invention differ from those acted upon by Mader's bridle. In the current invention, when a person's bands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. In Mader's bridle, when the reins are pulled, the nose strap is retracted, or tightened, about the nose of the horse and a pressure exerted on the nose, without any pressure being applied to the side of the horse's face and little pressure under the jaw.
5. Where the current invention has a noseband with a textured inner lining on the portion over the nose, with metal rings affixed at each side, that is adjustably attached to each side of the crownpiece, that encircles the horse's nose and closes in a buckle beneath the chin such that the ending portion of the noseband does not usually pass through the ring on the noseband. Mader's bridle differs in that the noseband passes only over the nose of the horse and is composed of a pair of contiguous cables having a centrally located spacer thereon. Functional differences associated with design of the noseband include: (a) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. In Mader's bridle, when the reins are pulled, the nose strap is tightened about the nose of the horse and a pressure exerted on the nose, without appreciable pressure also being applied to the jaw of the horse through the chin straps, or to other component parts of the bridle.

In a 1988 U.S. Pat. No. 4,722,17, Meroth discloses a bitless bridle comprising a crossover chin strap originating from a ring connecting the side and nose strap, that crosses over the opposing chin strap underneath the chin, passes through a depending chin strap receiving ring and terminates in reins. The noseband contains a flexible metal strip. Differences in structure between the current invention and Meroth's bridle alter the pattern of pressure points and thus the ultimate effect that each bridle produces on a horse.
1. Where the current invention has a crownpiece with a solid central section over the horse's poll and solid or bifurcated ends that extend down the side of the horse's head where they attach to reinstraps. Meroth's bridle differs in that it utilizes a crownpiece that passes only over the horse's poll and does not extend down the side of the horse's head and is not attached to reinstraps. Meroth's bridle utilizes a throatlatch that passes under the throat of the horse and connects the two sides of the crownpiece while the current invention has no similar device. Functional differences associated with design of the crownpiece include: (a) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. In Meroth's bridle, when a person's hands act on reins attached to the rings of the noseband, pressure from the reins is transferred to the rings of the noseband and the smooth upper portion of the noseband, but no pressure is transferred to the crownpiece over the poll.
2 Browbands of these, and most bridles, are similar
3. Where an integral part of the current invention is a crossover reinstrap stabilizer: a circle of leather with opposing slots that connects two reinstraps as they cross through under the horse's jaw, Meroth's bridle uses guide rings attached to the noseband to ensure that the X shaped crossover of the reins remains under the horse's chin. The reinstraps of Meroth's bridle cross under the horse's chin but are not connected to each other in any way. Functional differences associated with design of the crossover reinstrap stabilizer include: (a) The crossover reinstrap stabilizer of the current invention maintains the reinstraps in a constant position on the side of the horse's head and underneath the jaw. In Meroth's bridle, the reinstraps are not connected and the position may not be adjusted; as rein pressure varies, the reinstraps may slip to different positions. (b) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. In Meroth's bridle, reinsiraps do not cross the horse's cheek, the traction exerted by one or both reins exerts pressure substantially only on the rings and the smooth upper portion of the noseband, thus limiting turning and stopping control. (c) In the current invention, pressure on the crossover reinstrap stabilizer signals the horse to turn or slow. No similar pressure is applied under the jaw by the Meroth bridle with reinstraps that cross beneath the horse's chin,
4. Where the current invention has a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, Meroth's bridle differs in that reinstraps are attached directly to rings on each side of the noseband, cross under the horse's chin and pass through guide rings on the opposite side of the mouth from which they are attached. The reinstraps of Meroth's bridle cross under the chin rather than adjustably under the jaw and do not cross the horse's cheek or connect to the crownpiece of the bridle. Functional differences associated with design of the reinstraps include: (a) The reinstraps of the current invention that terminate where they connect to the solid crownpiece are maintained in a constant position with equal length on each side of the horse's head. In the current invention, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with marginal pressure transferred to the solid crownpiece over the poll. Traction applied to reinstraps of Meroth's bridle does not transfer any pressure to the side of the horse's head, to the poll or to the area under the jaw. In Meroth's bridle, the traction exerted by either or both reins exerts pressure substantially only on the horse's nose.
5. Where the current invention has a noseband with a textured inner lining on the portion over the nose, with metal rings affixed at each side, that is adjustably attached to each side of the crownpiece, that encircles the horse's nose and closes in a buckle beneath the chin such that the ending portion of the noseband does not usually pass through the ring on the noseband, Meroth's bridle employs a noseband with a smooth/soft lining containing a flexible metal strip that passes only over the nose of the horse. Functional differences associated with design of the roseband include: (a) The smooth material on the underside noseband of Meroth's bridle allows the noseband to slip to different positions on the horse's nose when rein pressure varies or if the horse tosses its head; if the smooth noseband slides up on the horse's face, the horse can evade slowing or stopping. (b) The current invention utilizes a noseband that is adjustably attached to each side of the crownpiece and that buckles under the chin to allow the user to adjust it to rest in an optimal position on the horse's nose so as to maximize control when pulling on one or both reins without restricting the horse's breathing. Meroth's bridle does not buckle under the chin, so it may slide higher on the horse's nose to diminish control.

In a 1999 patent WO99/62331 (U.S. Pat. No. 6,595,156 B1), Curran discloses an animal halter comprising a double “D” connector. The connector receives two nose straps that terminate in two cheek straps. Although primarily designed for dogs, Curran describes an embodiment fitted to a horse that includes an anchor portion formed by a pair of straps that are interconnected by a nose band. The nape portion comprises a head strap that terminates in a set of rings. When fitted, the noseband passes over the muzzle of the horse and the headband passes across the back of the head behind the ears. The straps extend from opposite ends of the headband and cross beneath the mouth of the horse at a constraint. Differences in structure between the current invention and Curran's bridle alter the pattern of pressure points and thus the ultimate effect that each bridle produces on a horse.
1. Where the current invention has a crownpiece with a solid central section over the horse's poll and solid or bifurcated ends that extend down the side of the horse's head. Curran's bridle differs in that the headband piece of Curran's bridle passes only over the back of the head of the horse, through rings where the reinstraps are attached, terminating in another set of rings for optional attachment of reins. Functional differences associated with design of the crownpiece include: (a) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's head, with only marginal pressure transferred to the solid crownpiece over the poll. In Curran's bridle, when a person's hands act on reins attached to the bridle's reinstraps, pressure from the reinstraps is transferred to the rings of the noseband and the smooth upper portion of the noseband, to the reinstrap on the opposite side of the horse's head, with significant pressure transferred through the ring connector to the solid centerpiece over the poll.
2. Where the current invention has a browband that connects to each side of the crownpiece, Curran's bridle shows no browband. Functional differences associated with design of the browbands include (a) Because Curran's bridle has no browband, the crownpiece may slip farther back on the horse's head and fail to apply pressure to the poll. (b) Because each reinstrap of the current invention terminates where it connects to the solid crownpiece, each reinstrap maintains an equal length on each side of the horse's head. Because the reinstraps of Curran's bridle connect to a crownpiece that passes over the poll of the horse that is not connected to a browband to hold it in front of the horse's ears, if excessive pressure is applied to one rein, the crownpiece and reinstraps may slip around the horse's head and become uneven with more reinstrap on one side than of the head than the other. This in turn causes the reins to become uneven in length, which diminishes turning and stopping control.
3. Where an integral part of the current invention is a crossover reinstrap stabilizer: a circle of leather with opposing slots that connects two reinstraps as they cross through under the horse's jaw, the reinstraps of Curran's bridle pass through a device under the horse's chin that appears to be a ring and is described as a constraint but does not snugly connect the reinstraps. Functional differences associated with design of the crossover reinstrap stabilizer include: (a) The crossover reinstrap stabilizer of the current invention maintains the reinstraps in a constant position on the side of the horse's head and underneath the jaw. In Curran's bridle, as rein pressure varies, the independent reinstraps may slip to different positions or fall completely off the side of the horse's face thus lessening the ability to turn the horse. (b) In the current invention, when a person's hands act on reins attached to the bridle's reinstraps, pressure from the reinstraps is transferred to the rings of the noseband and the textured inner lining on the portion over the nose, to the crossover reinstrap stabilizer under the jaw and through the crossover reinstrap stabilizer to the reinstrap on the opposite side of the horse's head, with marginal pressure transferred to the solid crownpiece over the poll. In Curran's bridle, if the reinstraps have slipped from the horse's cheek, the traction exerted by one or both reins exerts pressure substantially only on the rings of the noseband and the smooth upper portion of the noseband, thus limiting turning and stopping control. (c) In the current invention, pressure on the crossover reinstrap stabilizer signals the horse to turn or slow. No similar pressure is applied under the jaw by the Curran bridle.
4. Where the current invention has a set of two reinstraps that terminate on one end in metal rings, cross over each other as they pass through a crossover reinstap stabilizer and have a buckle on the other end that serves to attach them to the sides of the crownpiece so the overall length may be adjusted so the terminating rings are positioned close to the horse's mouth, Curran's bridle differs in that the reinstraps are not connected to each other in any ways and are firmly attached to rings of the crownpiece with no adjustment available to overall length. Functional differences associated with design of the reinstraps include: (a) The adjustable length reinstraps of the current invention improve communication with the horse and allow this bridle to more closely mimic the action of a bitted bridle. In the Curran bridle, the reinstraps may extend well beyond the horse's mouth so the reins attach far away from the normal position for a bitted bridle, causing a delay or distortion in transfer of pressure from the reins to noseband and remaining bridle components, thus creating poorer communication between rider/driver and horse and diminishing rein control. (b) In Curran's bridle, traction exerted by reins exerts pressure substantially only on the horse's nose.
5. Where the current invention has a noseband with a textured inner lining on the portion over the nose, with metal rings affixed at each side, that is adjustably attached to each side of the crownpiece, that encircles the horse's nose and closes in a buckle beneath the chin such that the ending portion of the noseband does not usually pass through the ring on the noseband, Curran's bridle differs in that the noseband is not attached to the crownpiece, has a smooth lining over the upper portion and only passes over the upper portion of the horse's nose. Functional differences associated with design of the noseband include: (a) The smooth material on the underside of the noseband of Curran's bridle allows the noseband to slip to different positions on the horse's nose when rein pressure varies or if the horse tosses its head, if the smooth noseband slides up on the horse's face, the horse can evade slowing or stopping. (b) The current invention utilizes a noseband that is adjustably attached to each side of the crownpiece and that buckles under the chin to allow the user to adjust it to rest in an optimal position on the horse's nose so as to maximize control when pulling on one or both reins without restricting the horse's breathing. Curran's bridle does not attach to the crownpiece or buckle under the chin, so it may slide higher on the horse's nose to diminish control or lower on the nose to restrict breathing.

In a 2002 US Patent Application 2002/0148207, Cook discloses a bitless bridle that comprises an elongated strap which includes a center piece at the polls and two crossover straps at the sides, attachable to a pair of reins providing a direct link between the centerpiece and the reins. Differences in structure between the current invention and Cook's bridle alter the pattern of pressure points and thus the ultimate effect that each bridle produces on a horse.
1. Where the current invention has a crownpiece with a solid central section over the horse's poll and solid or bifurcated ends that extend down the side of the horse's head, Cook's bridle differs in that it utilizes a combination of a crownpiece with solid ends that extend down the side of the horse's head and a second separate centrepiece that also passes over the poll of the horse and is a continuation of the reinstraps. While the crownpiece of the current invention is smooth and solid, the centrepiece of the Cook bridle is provided with a plurality of holes where studs or protuberances may be mounted on the inner surface. Functional differences associated with design of the crownpiece include: (a) In the current invention, when a person's hands act on reins attached to the bridle's reinstraps, pressure from the reinstraps is transferred to the rings of the noseband with a textured inner lining on the portion over the nose, to the crossover reinstrap stabilizer under the jaw and through the crossover reinstrap stabilizer to the reinstrap on the opposite side of the horse's head, with only marginal pressure transferred to the solid crownpiece over the poll. In Cook's bridle, when a person's hands act on reins attached to the bridle's reinstraps, pressure from the reinstraps is transferred to the rings of the noseband and the smooth upper portion of the noseband, to the reinstrap on the opposite side of the horse's head, with significant pressure transferred to the solid centerpiece over the poll where that poll pressure may be intensified by studs or protuberances that may be mounted on the inner surface of the centerpiece. (b) Because each reinstrap of the current invention terminates where it connects to the solid crownpiece, each reinstrap maintains an equal length on each side of the horse's head. Because the reinstraps of Cook's bridle are a continuous piece that passes over the poll of the horse in the centrepiece, if excessive pressure is applied to one rein, the reinstraps may slip around the horse's head and become uneven with more reinstrap on one side than of the head than the other. This in turn causes the reins to become uneven in length, which diminishes turning and stopping control.
2. Browbands of these, and most bridles, are similar
3. Where an integral part of the current invention is a crossover reinstrap stabilizer: a circle of leather with opposing slots that connects two reinstraps as they cross through under the horse's jaw, Cook's bridle has no comparable feature, and the reinstraps of Cook's bridle are not connected to each other in any way. Functional differences associated with design of the crossover reinstrap stabilizer include: (a) The crossover reinstrap stabilizer of the current invention maintains the reinstraps in a constant position on the side of the horse's head and underneath the jaw. In Cook's bridle, as rein pressure varies, the independent reinstraps may slip to different positions, fall completely off the side of the horse's face and/or become tangled under the jaw of the horse thus lessening the ability to turn the horse. (b) In the current invention, when a person's hands act on reins attached to the bridle's reinstraps, pressure from the reinstraps is transferred to the rings of the noseband and the textured upper portion of the noseband, to the crossover reinstrap stabilizer under the jaw and through the crossover reinstrap stabilizer to the reinstrap on the opposite side of the horse's bead, with marginal pressure transferred to the solid crownpiece over the poll. In Cook's bridle, if the reinstraps have slipped from the horse's cheek or become tangled under the jaw, the traction exerted by one or both reins exerts pressure substantially only on the rings of the noseband and the smooth upper portion of the noseband, thus limiting turning and stopping control. (c) In the current invention, pressure on the crossover reinstrap stabilizer signals the horse to turn or slow. No similar pressure is applied under the jaw by the Cook bridle with independent reinstraps.

4. Where the current invention has a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, Cook's bridle differs in that the reinstraps are not connected to each other in any way, and the overall length is such that at their shortest setting the terminating rings are positioned far from the horse's mouth, approximately 25 to 35 cm from the horse's lipcrease. Functional differences associated with design of the reinstraps include: (a) The shorter reinstraps of the current invention improve communication with the horse and allow this bridle to more closely mimic the action of a bitted bridle. In the Cook bridle, at their shortest setting the reinstraps extend well beyond the horse's mouth so the reins attach far away from the normal position for a bitted bridle, causing a delay or distortion in transfer of pressure from the reins to the noseband rings and remaining bridle components, thus creating poorer communication between rider/driver and horse and diminishing rein control. (b) The reinstraps of the current invention that terminate where they connect to the solid crownpiece are maintained in a constant position with equal length on each side of the horse's head. Because the reinstraps of Cook's bridle are a continuous piece that passes over the poll of the horse in the centrepiece, if excessive pressure is applied to one rein, they may slip around the horse's head and become uneven with more reinstrap on one side than of the head than the other. This in turn causes the reins or driving lines to become uneven in length, which diminishes turning and stopping control.
5. Where the current invention has a noseband with a textured inner lining on the portion over the nose, with metal rings affixed at each side, that is adjustably attached to each side of the crownpiece, that encircles the horse's nose and closes in a buckle beneath the chin such that the ending portion of the noseband does not usually pass through the ring on the noseband, Cook's bridle differs in that the noseband has a smooth lining over the upper portion and it closes in a buckle near the side of the horse's mouth such that the ending portion of the noseband usually passes through a ring on the noseband. Functional differences associated with design of the noseband include: (a) The smooth material on the underside noseband of Cook's bridle allows the noseband to slip to different positions on the horse's nose when rein pressure varies or if the horse tosses its head; if the smooth noseband slides up on the horse's face, the horse can evade slowing or stopping. (b) Because the noseband of the Cook bridle is designed such that it buckles close to the noseband ring, the ending strap of the noseband interferes with the free movement of the reinstrap through the ring.

### TECHNICAL PROBLEM ADDRESSED

I have found that the disadvantage of other bitless bridles caused by the crossover straps becoming twisted under the horse's chin and failing to maintain consistent contact with the cheek can be overcome by threading reinstraps through a crossover reinstrap stabilizer that holds the reinstraps relatively snugly but not tightly under the horse's jaw to prevent their twisting and maintain the position of the reinstraps on the largest part of the horse's cheeks. The crossover reinstrap stabilizer creates a unique system of pressure points. In the current invention, when a person's hands act on reins attached to the bridle's reinstraps, pressure from the reinstraps is transferred to the rings of the noseband with a textured inner lining on the portion over the nose, to the crossover reinstrap stabilizer under the jaw and through the crossover reinstrap stabilizer to the reinstrap on the opposite side of the horse's head, with only marginal pressure transferred to the solid crownpiece over the poll. Pulling on a single rein transfers pressure through the connecting ring to the reinstrap, to the noseband ring then through crossover reinstrap stabilizer, to the portion of the reinstrap that is held consistently on the opposite side of the horse's head. The pull on a single rein creates a diagonal pressure that pulls the entire horse's head in the direction pulled. Releasing the pull on the rein removes the pressure and rewards the horse. The crossover reinstrap stabilizer also assists in slowing or stopping the horse; pulling back on both reins signals the horse to slow or stop by causing pressure on the crossover reinstrap stabilizer under the jaw, as well as the textured noseband and the solid crownpiece over the poll.

The diminished turning and slowing/stopping capability of other bitless bridles is also improved by arrangement of component straps of the current invention, in particular by replacing the longer crossover straps of some bitless bridles with shorter reinstraps adjustable such that reins may be attached very close to the horse's mouth, similar to their traditional placement with a bit.

The disadvantage of other bitless bridles allowing the noseband to slip on the horse's nose, and the horse to toss its head to evade slowing or stopping is reduced by fixing rubber gripping or similar textured material to the inside of the noseband to improve contact with the horse's nose.

The disadvantage of the ending strap of other bitless bridles' nosebands interfering with the free movement of the reinstraps is overcome in the current invention by positioning the buckle of the noseband directly under the horse's chin such that the ending strap does not interfere with the free movement of the reinstraps.

These design improvements also enable the current invention to be easily manufactured in two styles to appeal to more equestrian enthusiasts, by simply modifying the crownpiece. The English style has a bifurcated crownpiece with a separate connection for the noseband. The Western style is created with a solid crownpiece with a single connection for the noseband and reinstraps.

I claim:

1. A bitless bridle for riding, driving and training horses or like animals that controls turning, slowing or stopping a horse by transferring pressure from a person's hands on reins to specific points on the horse's head, said bridle consisting of:
in English style a, crownpiece strap having a solid portion over the poll and left and right bifurcated end portions for positioning alongside left and right sides of a horse's head, in Western style, a single crownpiece strap having a solid portion over the poll and left and right solid end portions for positioning alongside left and right sides of a horse's head,
in both styles, a browband that connects to each side of the crownpiece,
in both styles, a crossover reinstrap stabilizer: a circle of leather with opposing slots that connects two reinstraps as they cross through it beneath the horse's jaw,
in both styles, a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, approximately 5 to 15 cm from the horse's lipcrease,
in both styles, a noseband with a textured inner lining on the portion over the nose; with metal rings affixed at each side; that is adjustably attached to each side of the crownpiece; that encircles the horse's nose and closes in a buckle beneath the chin.

2. A bitless bridle in English style according to claim 1, wherein said crownpiece strap is constructed of material approximately 3.5 cm in width, said material being solid for the centre approximate ⅓ of its length with each ⅓ end section split to form bifurcated ends.

3. A bitless bridle in English style according to claim 1, wherein said crownpiece strap is comprised of two individual straps of material, each approximately 1.75 cm in width, which are fixedly joined for approximately ⅓ of their length in the centre.

4. A bitless bridle in Western style according to claim 1, wherein said crownpiece strap is comprised of a solid material for its entire length.

5. A bitless bridle according to claim 1, further comprising a browband that connects to each side of the crown piece, that is provided on each end with metal clasps to constrict the brow band on said crownpiece.

6. A bitless bridle according to claim 1, further comprising a crossover reinstrap stabilizer that is comprised of a circular disc of material similar in strength to leather, approximately 5.5 cm in diameter and 3 mm thick with two opposing sets of slots approximately 2 cm in length and 0.7 cm from the outer edge of the disc.

7. A bitless bridle according to claim 1, further comprising a set of left and right reinstraps comprised of adjustable length straps.

8. A bitless bridle according to claim 7, wherein said left and right reinstraps are threaded through the opposing slots in said crossover reinstrap stabilizer such that the left reinstrap passes through the crossover reinstrap stabilizer to end on the right side of said horse's face, and the right reinstrap passes through the crossover reinstrap stabilizer to end on the left side of said horse's face.

9. A bitless bridle according to claim 7, wherein the first adjustment mechanism comprises a buckle on one terminal end of each reinstrap.

10. A bitless bridle according to claim 7, further comprising a second adjustment mechanism for adjusting and maintaining the position of the said reinstraps relative to the side of the head of the animal.

11. A bitless bridle according to claim 10, wherein said second adjustment mechanism consists of said crossover reinstrap stabilizer, such that the position of the crossover reinstrap stabilizer may be adjusted relative to the length of the reinstraps in order to position the reinstraps on the largest portion of the horse's cheek.

12. A bitless bridle according to claim 7 wherein said set of reinstraps terminate in a connector mechanism for allowing said reinstraps to be attached to a pair of reins.

13. A bitless bridle according to claim 12 wherein each connector mechanism comprises a circular ring element.

14. A bitless bridle according to claim 1, further comprising a noseband having first and second ends wherein said first end is secured to said second end by an adjustment mechanism.

15. A bitless bridle according to claim 14, wherein said first adjustment mechanism comprises a buckle that is normally positioned centrally under the horses chin.

16. A bitless bridle according to claim 14 wherein said nose band has left and right cheekpiece straps securely attached approximately ⅓ of the distance from the ends of said noseband to the midpoint of said noseband.

17. A bitless bridle according to claim 16 wherein said left and right cheekpiece straps are connected to said left and right end portions of the said crownpiece by a second adjustment mechanism comprised of buckles.

18. A bitless bridle according to claim 14, further comprising a pair of circular ring elements fixedly attached to said noseband for creating a sliding connection for said reinstraps on the opposite sides of the animal's head adjacent to the mouth of the animal.

19. A bitless bridle according to claim 1, wherein said terminal circular ring elements of said reinstraps extend beyond the sliding connectors by an amount sufficient to position said circular ring elements in a variety of positions.

20. A bitless bridle according to claim 1, wherein said terminal circular ring elements of said reinstraps are normally positioned approximately 5-15 cm beyond said sliding connectors.

21. A bitless bridle according to claim 14 wherein the inside of said nose band, the side closest to the horse's nose, is lined with a layer of rubber gripping or like material to provide a textured surface.

22. A bitless bridle according to claim 14 wherein said rubber gripping or like material is fixedly attached to said noseband strap between said pair of sliding connectors.

23. A bitless bridle English style for riding, driving and training horses or like animals that controls turning, slowing or stopping a horse by transferring pressure from a person's hands on reins to specific points on the horse's head, said bridle consisting of:
a crownpiece with a solid central section over the horse's poll and bifurcated ends that extend down the side of the horse's head,
a browband that connects to each side of the crownpiece,
a crossover reinstrap stabilizer: a circle of leather with opposing slots that connects two reinstraps as they cross through it beneath the horse's jaw,
a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, approximately 5 to 15 cm from the horse's lipcrease,
a noseband with a textured inner lining on the portion over the nose; with metal rings affixed at each side; that is adjustably attached to each side of the crownpiece; that encircles the horse's nose and closes in a buckle beneath the chin.

24. A bitless bridle in Western style for riding, driving and training horses or like animals that controls turning, slowing or stopping a horse by transferring pressure from a person's hands on reins to specific points on the horse's head, said bridle consisting of:
a crownpiece with a solid central section over the horse's poll and ends that extend down the side of the horse's head,
a browband that connects to each side of the crownpiece,
a crossover reinstrap stabilizer: a circle of leather with opposing slots that connects two reinstraps as they cross through it beneath the horse's jaw,
a set of two reinstraps that terminate on one end in metal rings, cross over each other as they pass through a crossover reinstrap stabilizer and have a buckle on the other end that serves to attach them to the sides of the crownpiece so the overall length may be adjusted so the terminating rings are positioned close to the horse's mouth, approximately 5 to 15 cm from the horse's lipcrease,
a noseband with a textured inner lining on the portion over the nose; with metal rings affixed at each side; that is adjustably attached to each side of the crownpiece; that encircles the horse's nose and closes in a buckle beneath the chin.
